(19) United States
(12) Patent Application Publication
(10) Pub. No.: US 2021/0006938 A1
(43) Pub. Date: Jan. 7, 2021

(54) METHOD FOR TRANSMITTING AND RECEIVING DATA USING PUBLISH/SUBSCRIBE MIDDLEWARE

(71) Applicant: dSPACE digital signal processing and control engineering GmbH, Paderborn (DE)

(72) Inventors: Sebastian Schulte, Paderborn (DE); Younus Dhannoon Younus, Paderborn (DE)

(21) Appl. No.: 16/737,970

(22) Filed: Jan. 9, 2020

(30) Foreign Application Priority Data
Jul. 3, 2019 (DE) 102019117914.9

(51) Int. Cl. H04W 4/02; H04W 4/024; H04W 4/029; G01C 21/34

(52) U.S. Cl. CPC H04W 4/023; G01C 21/3446; H04W 4/029; H04W 4/024

(57) ABSTRACT

A transmitter of a publisher device transmits data to a server, and a receiver of a subscriber device receives the data. A publish/subscribe middleware is utilized to provide to-be-sent data with a data identifier and for selection of to-be-received data based on the data identifier.

### CROSS-REFERENCE TO PRIOR APPLICATION

Priority is claimed to German Patent Application No. DE 102019117914.9, filed on Jul. 3, 2019, the entire disclosure of which is hereby incorporated by reference herein.

### FIELD

The present invention relates to a method for transmitting data from a transmitter to a server and for receiving such data that has been transmitted to the server at a receiver

### BACKGROUND

Status information of motor vehicles can be automatically transmitted to a server by the motor vehicles or occupants of the motor vehicles. Up to now, it has been of particular interest to provide motor vehicle status information that relates to traffic and thus allows for improved route planning, avoiding traffic jams, for example. In addition to the transmission of status information, such a system also requires simultaneous transmission of information regarding the coordinates of the geographical location of the motor vehicle. One such system (known in in practice) is Google Traffic™.

As described, for example, in DE 10 2018 004 671 A1, Google Traffic is a supplementary service of Google Maps that displays traffic conditions on major roads and highways in real-time. Google traffic can be viewed on the website of Google Maps or using the Google Maps app on a portable device, such as a smartphone. Google Traffic works by analyzing the locations that are determined and transmitted to Google™ by a large number of mobile phone users. By calculating the speed of users, Google is able to generate a live traffic map. Google processes the incoming raw data about mobile device locations, and then excludes anomalies such as a postal vehicle which makes frequent stops. When a threshold of users in a particular area is noted, an overlay along roads and highways on the Google map changes color. However, one disadvantage of Google Traffic is that it refers only to the current traffic situation on the road, i.e. it provides a snapshot of the current traffic situation. However, the current traffic situation may be impacted, for example, by an accident, roadworks, etc., so that a vehicle that gets there at a later point in time may encounter a changed traffic situation.

Thus, DE 10 2018 004 671 A1 itself describes a method and a control system for vehicle route planning, the method including: collecting large amounts of data including geographical position, time and vehicle data of a large number of vehicles over a period of time, storing the collected big data information in a memory device that is external to the vehicle and associated with road map data, receiving a route planning request including a starting point, a destination of the vehicle and a point in time, receiving a set of vehicle-related boundary conditions, planning the route for the vehicle based on the received route planning request, the received set of boundary conditions, the collected and stored big data information and the road map data, and providing the planned route to the vehicle.

However, especially in the presence of large amounts of data, transmitting data from a transmitter to a receiver is difficult without knowing the answers to questions such as: “What is the address of the receiver?”, “Is the receiver available or not available?” or “What data are of interest to the receiver?”. This problem can be solved using middleware that provides a communication protocol. In this connection, the transmitter and receiver merely indicate that they transmit or receive data with a specific identifier (topic), but the receiver is not explicitly addressed. With regard to software architecture, middleware with a publish/subscribe service is a type of message or data transmission in which the senders of messages, called “publishers”, do not transmit the messages directly to specific receivers, called “subscribers”, but categorize published messages into classes without knowledge of which subscribers, if any, there may be. Similarly, subscribers express interest in one or more classes and thus only receive messages that are of interest to themselves, without knowledge of which publishers, if any, there are.

Such publish/subscribe services are akin to the message queue paradigms and are typically a part of a larger, message-oriented middleware system. Most messaging systems support both the pub/sub model and the message queue model in their application programming interface (API), e.g., Java Message Service (JMS). This type of data exchange provides greater network scalability and a more dynamic network topology, which results in reduced flexibility in modifying the publisher and the structure of the published data.

In order to distinguish data which are exchanged using publish/subscribe middleware, so-called topics are used. These topics are usually character strings, such as, for example, the character string “temperature” when the intention is to indicate temperature. Accordingly, a publisher can send its data with the topic “temperature.” A subscriber may in turn subscribe to the topic “temperature” in order to obtain the data from all temperature publishers.

When motor vehicles transmit status information to a server and other vehicles want to use this status information for applications such as traffic jam warning, collision detection, etc., there is the problem that even if only 1% of the about 45 million motor vehicles in Germany, for example, were included, there would still be about 450,000 vehicles, and thus 450,000 transmitters, that would each transmit data such as position, speed, direction and destination, to all other vehicles. However, such a large amount of data cannot be handled efficiently, so that the data volume needs to be restricted. This problem is currently addressed using protocol extensions, such as by GeoMQTT.

The message queue and telemetry transport (MQTT) protocol is a very lightweight protocol often used in the Internet of Things and Service (IoTS). It is especially suitable for constrained devices as well as low-bandwidth, high-latency and unreliable networks. In 2013, it was standardized by the Organization for the Advancement of Structured Information Standards (OASIS). The protocol implements the so-called publish/subscribe interaction scheme, an event-based communication model between publishers that produce certain information and subscribers that subscribe to this information. The term “event” is used for the act of publishing information, while “notification” denotes the act of delivery to the subscriber. A broker distributes the information according to the interests of the subscribers. MQTT uses a topic-based publish/subscribe scheme for addressing. MQTT was extended with message types that support spatio-temporal tagging and filtering of events. This extension is called GeoMQTT. It still uses a publish/subscribe interaction scheme, which in particular is not solely topic-based but also timestamp- and geometry-based. However, the topic mechanism is inherited from MQTT. Subscribers are able to specify their interests in geo events by using a topical, spatial and temporal filter. The broker then only forwards the so-called GeoPublish message to subscribers if all three filters are satisfied.

However, such protocol extensions are not included in the standard middleware protocols and represent deviations from the respective protocols.

### SUMMARY

In an exemplary embodiment, the present invention provides a method for transmitting data from a transmitter of a publisher device to a server and for receiving the data at a receiver of a subscriber device using publish/subscribe middleware that provides to-be-sent data with a data identifier and selects to-be-received data based on the data identifier. The method includes: acquiring, by the publisher device, coordinates of a geographical location of the publisher device within a predetermined coordinate system that is divided into a number of cells via a grid, wherein each cell is provided with a cell identifier and all coordinates of the coordinate system that identify a geographical location are assigned to exactly one cell; determining, by the publisher device, the cell identifier of the cell to which are assigned the acquired coordinates of the geographical location of the publisher device; determining, by the publisher device, the data identifier based on the determined cell identifier using a predetermined association rule; transmitting, by the publisher device via the transmitter, the data together with the data identifier from the publisher device to the server; storing, by the server, the data on the server; acquiring, by the subscriber device, the coordinates of a geographical location that is of interest to the subscriber device within the predetermined coordinate system; determining, by the subscriber device, the cell identifier of the cell to which are assigned the acquired coordinates of the geographical location that is of interest to the subscriber device; determining, by the subscriber device, the data identifier based on the determined cell identifier using the predetermined association rule; and receiving, by the subscriber device via the receiver, data from the server corresponding to the determined data identifier.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically shows a system for using a method in accordance with a preferred exemplary embodiment of the invention;

FIG. 2 schematically shows the publishing function according to the method described herein; and

FIG. 3 schematically shows the subscribe function according to the method described herein.

### DETAILED DESCRIPTION

Exemplary embodiments of the present invention provide geographic addressing (i.e., coordinate-based addressing) without extending standard protocols.

Thus, in accordance with the present invention, there is provided a method for transmitting data from a transmitter of a publisher device to a server and for receiving such data that has been transmitted to the server at a receiver of a subscriber device using publish/subscribe middleware that provides the data to be sent with a data identifier and selects data to be received with the aid of the data identifier, the method including the following steps:
acquiring, by the publisher device, the coordinates of the geographical location of the publisher device within a predetermined coordinate system that is divided into a large number of cells, each provided with a cell identifier, via a grid and in such a manner that all coordinates of the coordinate system that identify a geographical location are assigned to exactly one cell,
determining, by the publisher device, the cell identifier of the cell to which are assigned the acquired coordinates of the geographical location of the publisher device,
determining, by the publisher device, the data identifier as a function of the determined cell identifier using a predetermined association rule,
transmitting, by the publisher device, the data together with the data identifier from the publisher device to the server,
storing, by the server, the data on the server,
acquiring, by the subscriber device, the coordinates of a geographical location that is of interest to the subscriber device within the predetermined coordinate system,
determining, by the subscriber device, the cell identifier of the cell to which are assigned the acquired coordinates of the geographical location that is of interest to the subscriber device,
determining, by the subscriber device, the data identifier as a function of the determined cell identifier using the predetermined association rule, and
receiving, by the subscriber device via the receiver, data from the server and whose data identifier matches the predetermined data identifier.

The coordinates of the coordinate system that identify a geographical location are at least coordinate pairs (2D) or even coordinate triples (3D). Such coordinate pairs (or triples) are assigned to exactly one cell. Using geographical addressing, a subscriber device can thus select exactly the data that are of particular interest to it due to its geographical location, this being possible without extending standard protocols. If no data are stored on the server whose data identifiers would match the data identifier determined for the subscriber device, then, of course, no data are received at the subscriber device.

When the present description describes acquiring the coordinates of a geographical location that is of interest to the subscriber device, this means that a geographical location for which the subscriber device wants to receive data are, or has been, determined at the receiving end. As will be described in more detail below, this can be done in various ways, namely, e.g., using the location in which the subscriber device itself is situated, using a user-determinable location, or using an automatically determined location, which may be obtained, for example, in a route planning process.

Transmission and reception are typically performed wirelessly and preferably over a cellular network and/or a wireless local access network (WLAN) and/or another suitable wireless network. The transmitter of the publisher device and the receiver of the subscriber device may be implemented in very different ways, namely as a transmitter or receiver carried by a person or as a transmitter or receiver in a vehicle, such as an aircraft or a ship. Preferably, however, the transmitter and the receiver are integrated in a motor vehicle, and particularly preferably in a connected car. The term “connected car” refers to a motor vehicle that is equipped with Internet access and usually also WLAN, which allows the vehicle to share the Internet connection with other devices. Frequently, special technologies, sensors and methods are used in the vehicle so that this connectivity can provide advantages to the driver, such as automatic accident warning, automatic speeding warning, and safety warnings. These functions can be complemented using the present invention.

In accordance with preferred embodiments of the present invention, various alternatives may be provided for acquiring the coordinates of the geographical location that is of interest to the subscriber device within the predetermined coordinate system, namely:
acquiring the coordinates of the geographical location that is of interest to the subscriber device within the predetermined coordinate system by acquiring the coordinates of the geographical location of the subscriber device within the predetermined coordinate system, or
acquiring the coordinates of the geographical location that is of interest to the subscriber device within the predetermined coordinate system by acquiring manually entered information indicating the coordinates, or
acquiring the coordinates of the geographical location that is of interest to the subscriber device within the predetermined coordinate system by acquiring at least one coordinate, preferably all coordinates, of an automatically determined route between a starting point and an end point.

In the first case, where the coordinates of the geographical location of the subscriber device are acquired within the predetermined coordinate system in order to acquire the coordinates of the geographical location that is of interest to the subscriber device, the aim is to obtain information about the current geographical location of the subscriber device or the geographical location that the subscriber device is expected to reach in the near future. In the second case, where manually entered information indicating the coordinates is acquired, the user of the method is able to make a query for any location as desired. Finally, in the third case, it is possible to obtain information about an automatically determined route, such as possible road closures or traffic jams along this route.

Receiving at the subscriber device data that are stored on the server and whose data identifier matches the predetermined data identifier may generally suffice for the present invention. However, in accordance with a preferred embodiment of the present invention, the method includes the following additional steps:
determining at least one additional cell identifier of a cell that is immediately adjacent to the cell to which are assigned the coordinates of the geographical location that is of interest to the subscriber device,
determining an additional data identifier as a function of the additionally determined cell identifier using the predetermined association rule, and
additionally receiving at the subscriber device data that are stored on the server and whose data identifier matches the additionally determined data identifier.

Particularly preferably, the subscriber device receives data for all directly adjacent cells, provided that data are available for these cells, which in turn depends on whether a publisher device was present there. This makes it possible to also reliably cover the subscriber device's surroundings into which the subscriber device may move by also receiving data that are relevant there. In the case of a square grid made up of squares of the same size, each cell has eight such immediately adjacent cells, namely four cells adjacent a respective one of the four sides of the cell, and four cells adjacent a respective one of the four corners of the cell.

A preferred embodiment of the present invention further provides that each cell identifier have a data identifier assigned thereto in a one-to-one relationship based on the predetermined association rule. This is particularly preferably done using topic-based publish/subscribe middleware in which the data identifier is a topic. Preferably, the cell identifier is used is used as the topic for this purpose.

In principle, the cells of the grid may be designed differently in terms of type and shape. Preferably, however, it holds that all cells of the grid have the same size. In addition, it is particularly preferred for the grid to be two-dimensional and square or two-dimensional and hexagonal. A hexagonal grid has the advantage that a cell does not have eight adjacent cells, as in the case of a square grid, but only six directly adjacent cells, so that less data need to be received for detecting the surroundings of the cell.

The cells of the grid that are assigned to the respective coordinates may be determined in different ways, for example via a look-up table. However, in accordance with a preferred embodiment of the present invention, it holds that the cells of the grid that are assigned to the respective coordinates are each derived from the coordinates themselves. A particularly preferred embodiment of the present invention provides that the respective cell identifier of the cells be determined by using decimal numbers as the coordinates, shifting the decimal point of the decimal numbers a predetermined amount the right and subsequently cutting off the then remaining digits after the decimal point.

Alternatively, in a preferred embodiment of the present invention, the cells of the grid that are assigned to the respective coordinates are not each derived from the coordinates themselves. This is possible, for example, if the coordinates of the coordinate system are each assigned to exactly one cell using a discrete global grid system, preferably using the Icosahedral Snyder Equal Area (ISEA) grid or the HEALPix grid. A discrete global grid (DGG) is a mosaic that covers the whole surface of the Earth. Mathematically speaking, it is a division of space consisting of a set of non-empty regions that form a partition of the Earth's surface. In a usual grid-modeling strategy, to simplify position calculations, each region is represented by a point, abstracting the grid as a set of region points. Each region or region point in the grid is called a cell. ISEA discrete global grids (ISEA DGGs) are a class of grids originating from research at Oregon State University. The grid cells are created as regular polygons on the surface of an icosahedron, and then inversely projected using the ISEA map projection to form equal-area cells on the sphere. Cells may be hexagons, triangles, or quadrilaterals. Various resolutions are displayed by choosing an aperture or a ratio between cell areas in consecutive resolutions. A HEALPix grid has square cells of equal area and was originally developed for use with astrophysical data sets. These grids have the advantage that the cells do not become smaller at the polar caps.

In principle, it is possible to permanently store the data on the server. However, a preferred embodiment of the present invention provides for the data to be stored on the server only temporarily, preferably for a predetermined period of time. This also promotes efficient handling of the data and saves memory space.

As mentioned earlier herein, the method according to the present invention can be used in different situations. However, a preferred embodiment of the present invention provides for a method described hereinabove to be used with a plurality of motor vehicles, each motor vehicle being equipped with a transmitter, a receiver and a location sensor for carrying out the method. Such a location sensor is preferably a receiver for a satellite navigation system, such as global positioning system (GPS), Galileo or GLONASS.

Such use is preferably effected such that the transmitted or received data include data acquired by a sensor disposed in a motor vehicle. Such a sensor is preferably a temperature sensor, a speed sensor, an acceleration sensor, a rain sensor, a light sensor for sensing the light in the surroundings of the vehicle, or another sensor that senses a value that is relevant for the motor vehicle. Additionally or alternatively, the transmitted or received data include data output by an actuator that is disposed in a motor vehicle. Such an actuator is preferably a flasher, a windshield wiper, a light switch or another actuator for a function in one of the motor vehicles. It is also self-evident that data of a plurality of sensors and/or actuators may be used.

Furthermore, a preferred embodiment of the present use resides in that the transmitted or received data include data originating from a stationary device. For this purpose, such a stationary device has a transmitter by which data can be transmitted to the server. In addition, such a stationary device may also be equipped with a location sensor. Alternatively, the stationary device may be provided with fixed location information indicating its geographic location and used for transmitting data to the server. Particularly preferably, such a stationary device is a traffic infrastructure device that outputs motor vehicle traffic related information, such as a traffic light that transmits, for example, data about its current phase (red, green, yellow), or a parking access facility that transmits data about free parking spaces. It is self-evident that a plurality of such stationary devices may be used.

The following description of a preferred exemplary embodiment of the present invention again focuses on the example mentioned hereinabove, according to which the motor vehicles transmit status information to a server and other vehicles want to this status information for applications such as traffic jam warning, collision detection, etc.

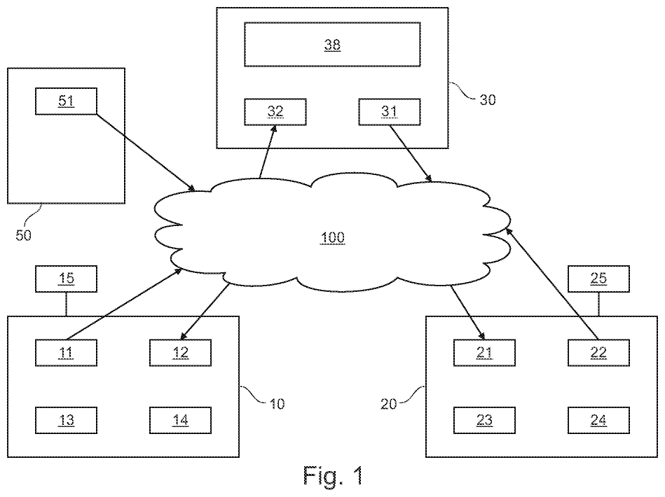

A system usable for such a method is exemplarily illustrated in FIG. 1. The system includes two motor vehicles 10, 20, each having a transmitter 11, 21, a receiver 12, 22, a sensor 13, 23, an actuator 14, 24 and a location sensor 15, 25. While each of location sensors 15, 25 is here in the form of a GPS receiver, sensors 13, 23 may be a temperature sensor, a speed sensor, an acceleration sensor, a rain sensor, a light sensor for sensing the light in the surroundings of the vehicle, or another sensor that senses a value that is relevant for motor vehicle 10, 20. Examples of possible actuators 14, 24 include a flasher, a windshield wiper, a light switch or another actuator for a function in one of motor vehicles 10, 20.

In addition, the system includes a stationary device 50 equipped with a transmitter 51. Stationary device 50 does not have a location sensor, but is provided with fixed location information that indicates its geographic location. In the present case, stationary device 50 is a traffic infrastructure facility that outputs motor vehicle traffic related information, namely a traffic light that transmits data about its current phase (red, green, yellow).

Data generated with the aid of sensors 13, 23 and/or actuators 14, 24 and/or stationary device 50 can be sent by transmitters 11, 21, 51 over a cellular network 100 and received by receivers 12, 22, over cellular network 100. Thus, a communication with a server 30 takes place, which server also has a transmitter 31 and a receiver 32 that allow it to communicate over cellular network 100. Server 30 is further equipped with a memory 38, on which data received from motor vehicles 10, 20 are temporarily stored for a predetermined period of time.

In the present case, only two motor vehicles 10, 20 and one stationary device 50 are shown by way of example. In practice, however, there is the problem that even if only 1% of the about 45 million motor vehicles in Germany, for example, were included, there would still be about 450,000 vehicles, and thus 450,000 transmitters, that would each transmit data such as position, speed, direction, etc., to all other vehicles. However, such a large amount of data cannot be handled efficiently, so that the data volume needs to be restricted.

In accordance with the presently described preferred exemplary embodiment of the invention, this problem is solved by a topic scheme that generates geographical addresses using a predetermined scheme. In the present case, for example, the well-known World Geodetic System (WGS) 1984 coordinate system is used, which is divided into cells. Each coordinate can thus be uniquely assigned to a cell of the grid. This grid is then used as a topic. In accordance with the present exemplary embodiment, the coordinate 51,721033; 8,736438, at which, for example, one of the two motor vehicles 10, 20 is located, is converted into a simple cell identifier by moving the decimal point and cutting off the digits after the decimal point:

cell identifier=(floor (latitude*x), floor (longitude*x)),

where x is a natural number not equal to zero.

Thus, the topic uses the following cell identifier for the above-mentioned coordinate: (5172, 873) for an x of 100. In other words: All coordinates from 51.720000 through 51.729999 and from 8.730000 through 8.739999 use (5172, 873) as the cell identifier. In the transmission of speed data (marked with “speed”), the topic is obtained in the form of the following syntax:

<cell identifier_latitude>/<cell identifier_longitude>/speed

or more specifically as the topic:

5172/873/speed

Thus, there is provided a method for transmitting data from transmitters 11, 21 to server 30 and for receiving such data that has been transmitted to the server 30 at receivers 12, 22 using publish/subscribe middleware that provides the data to be sent with a data identifier and selects data to be received with the aid of the data identifier. This will now be described in more detail with reference to the following specific embodiment.

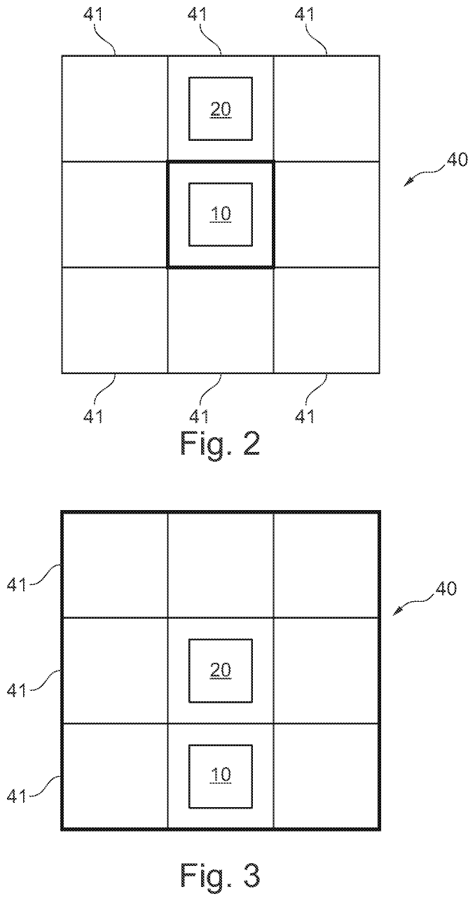

FIG. 2, which schematically illustrates the publishing function according to the method described herein, shows for this purpose a portion of a grid 40 of a coordinate system including a large number of cells 41, where all coordinates of the coordinate system that identify a geographical location are assigned to exactly one cell 41. First motor vehicle 10 is located in one of the cells 41 and second motor vehicle 20 is located in another (here adjacent) cell 41. In accordance with the here-described preferred exemplary embodiment of the present invention, each of the two vehicles 10, 20 is equipped with a transmitter 11, 21 and a receiver 12, 22. However, the present considerations are directed solely to a situation where first motor vehicle 10 transmits data to server 30 and second motor vehicle 20 receives data from server 30.

To this end, in a first step, the geographical location of first motor vehicle 10 is detected with the presently active transmitter 11 within the coordinate system. The coordinate system is divided into a large number of cells, each provided with a cell identifier, via the grid and in such a manner that all coordinates of the coordinate system that identify a geographical location are assigned to exactly one cell 41. This makes it possible to determine, in a next step, the cell identifier of the cell 41 to which are assigned the acquired coordinates of the geographical location of first motor vehicle 10 with transmitter 11. Then, the data identifier is determined as a function of the determined cell identifier using a predetermined association rule. In the present case, due to the predetermined association rule, a data identifier is assigned to each cell identifier in a one-to-one relationship using the previously mentioned topic-based publish/subscribe middleware, in which the data identifier is a topic and the cell identifier is used as the topic. In FIG. 2, the cell 41 in which the first vehicle 10 is located and for which the data are transmitted to server 30 is outlined in bold lines.

In the next step, the data, together with the data identifier, are transmitted from transmitter 11 of first motor vehicle 10 to server 30, and the data are stored temporarily in memory 38 on server 30. There, the data are then available for a predetermined time for retrieval and thus for the reception by a receiver of another motor vehicle, such as receiver 22 of second motor vehicle 20.

However, prior to such data retrieval, the coordinates of a geographical location that is of interest to receiver 22 of second motor vehicle 20 are determined within the predetermined coordinate system. The reason for this is that only information and data relating to geographical locations in which second vehicle 20 is located or which second vehicle 20 intends to drive to (e.g., along an automatically planned route) are of relevance to second vehicle 20. Thus, the acquisition of the coordinates of the geographical location that is of interest to receiver 22 of second vehicle 20 within the predetermined coordinate system may be accomplished, in particular, by acquiring the coordinates of the geographical location of second vehicle 20 within the predetermined coordinate system. Alternatively, the acquisition of the coordinates of the geographical location that is of interest to receiver 22 within the predetermined coordinate system may be accomplished by acquiring manually entered information indicating the coordinates. This allows a user to manually make a query. The acquisition of the coordinates of the geographical location that is of interest to receiver 22 within the predetermined coordinate system may further be accomplished by acquiring at least one coordinate, preferably all coordinates, of an automatically determined route between a starting point and an end point. In other words: in addition to planning a route to get from the starting point to the end point, information is retrieved about the waypoints to be passed along the route.

For such a query, the cell identifier of the cell to which are assigned the acquired coordinates of the geographical location that is of interest to receiver 22 is determined, the data identifier is determined as a function of the determined cell identifier using the predetermined association rule, and data that are stored in memory 38 of server 30 and whose data identifiers match the predetermined data identifier are received at receiver 22.

The method may be adapted to include determining additional cell identifiers of cells 41 that are immediately adjacent to the cell 41 to which are assigned the coordinates of the geographical location that is of interest to receiver 22. After determining the respective additional data identifiers as a function of the additionally determined cell identifiers using the predetermined association rule, data whose data identifiers match the additionally determined data identifiers are then received at receiver 22. This ensures that the surroundings of receiver 22 are also covered with respect to the information query.

This is exemplarily illustrated in FIG. 3, which schematically shows the subscribe function according to the method described herein. FIG. 3 shows a portion of grid 40 that is shifted by one cell 41 relative to the portion shown in FIG. 2. Here, the cells 41 for which the data are retrieved from server 30 are outlined in bold lines. These are the cell 41 in which second motor vehicle 20 is located and all directly adjacent cells 41. In the case of the here provided square grid made up of square cells 41 of the same size, each cell 41 has eight such immediately adjacent cells 41, namely four cells 41 adjacent a respective one of the four sides of the cell 41 and four cells 41 adjacent a respective one of the four corners of the cell 41. Alternatively, a hexagonal grid with hexagonal cells may be provided. A hexagonal grid has the advantage that a cell does not have eight adjacent cells, as in the case of a square grid, but only six directly adjacent cells, so that less data need to be retrieved for detecting the surroundings of the cell.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

10 first motor vehicle

11 transmitter of the first motor vehicle

12 receiver of the first motor vehicle

13 sensor of the first motor vehicle

14 actuator of the first motor vehicle

15 location sensor of the first motor vehicle

20 second motor vehicle

21 transmitter of the second motor vehicle

22 receiver of the second motor vehicle

23 sensor of the second motor vehicle

24 actuator of the second motor vehicle

25 location sensor of the second motor vehicle

30 server

31 transmitter of the server

32 receiver of the server

38 memory of the server

40 grid

41 cells of the grid

50 stationary device

51 transmitter of the stationary device

1. A method for transmitting data from a transmitter of a publisher device to a server and for receiving the data at a receiver of a subscriber device using publish/subscribe middleware that provides to-be-sent data with a data identifier and selects to-be-received data based on the data identifier, the method comprising:
acquiring, by the publisher device, coordinates of a geographical location of the publisher device within a predetermined coordinate system that is divided into a number of cells via a grid, wherein each cell is provided with a cell identifier and all coordinates of the coordinate system that identify a geographical location are assigned to exactly one cell;
determining, by the publisher device, the cell identifier of the cell to which are assigned the acquired coordinates of the geographical location of the publisher device;
determining, by the publisher device, the data identifier based on the determined cell identifier using a predetermined association rule;
transmitting, by the publisher device via the transmitter, the data together with the data identifier from the publisher device to the server;
storing, by the server, the data on the server;
acquiring, by the subscriber device, the coordinates of a geographical location that is of interest to the subscriber device within the predetermined coordinate system;
determining, by the subscriber device, the cell identifier of the cell to which are assigned the acquired coordinates of the geographical location that is of interest to the subscriber device;
determining, by the subscriber device, the data identifier based on the determined cell identifier using the predetermined association rule; and
receiving, by the subscriber device via the receiver, data from the server corresponding to the determined data identifier.

2. The method as recited in claim 1, wherein acquiring the coordinates of the geographical location that is of interest to the subscriber device within the predetermined coordinate system further comprises:
acquiring the coordinates of the geographical location of the subscriber device within the predetermined coordinate system; or
acquiring manually entered information indicating the coordinates; or
acquiring at least one coordinate of an automatically determined route between a starting point and an end point.

3. The method according to claim 1, further comprising:
determining at least one additional cell identifier of a cell that is immediately adjacent to the cell to which are assigned the coordinates of the geographical location that is of interest to the subscriber device;
determining at least one additional data identifier based on the at least one additional cell identifier using the predetermined association rule; and
additionally receiving at the subscriber device data from the server corresponding to the at least one additional data identifier.

4. The method as recited in claim 1, wherein each cell identifier has a data identifier assigned thereto in a one-to-one relationship based on the predetermined association rule.

5. The method as recited in claim 1, wherein the publish/subscribe middleware is a topic-based publish/subscribe middleware, and wherein the data identifier is a topic with respect to the topic-based publish/subscribe middleware.

6. The method as recited in claim 5, wherein the cell identifier is another topic with respect to the topic-based publish/subscribe middleware.

7. The method as recited in claim 1, wherein all cells of the grid have the same size.

8. The method as recited in claim 1, wherein the grid is two-dimensional and square or two-dimensional and hexagonal.

9. The method as recited in claim 1, wherein each cell of the grid is based on respective coordinates corresponding to the cell.

10. The method as recited in claim 1, wherein the coordinates of the coordinate system are each assigned to exactly one cell using a discrete global grid system.

11. The method as recited in claim 1, wherein the data are stored on the server temporarily.

12. A system for transmitting data from a transmitter of a publisher device to a server and for receiving the data at a receiver of a subscriber device using publish/subscribe middleware that provides to-be-sent data with a data identifier and selects to-be-received data based on the data identifier, the system comprising:
the publisher device, wherein the publisher device is configured to:
acquire coordinates of a geographical location of the publisher device within a predetermined coordinate system that is divided into a number of cells via a grid, wherein each cell is provided with a cell identifier and all coordinates of the coordinate system that identify a geographical location are assigned to exactly one cell;
determine the cell identifier of the cell to which are assigned the acquired coordinates of the geographical location of the publisher device;
determine the data identifier based on the determined cell identifier using a predetermined association rule;
transmit, via the transmitter, the data together with the data identifier from the publisher device to the server;
the server, wherein the server is configured to store the data on the server; and
the subscriber device, wherein the subscriber device is configured to:
acquire the coordinates of a geographical location that is of interest to the subscriber device within the predetermined coordinate system;
determine the cell identifier of the cell to which are assigned the acquired coordinates of the geographical location that is of interest to the subscriber device;
determine the data identifier based on the determined cell identifier using the predetermined association rule; and
receive, via the receiver, data from the server corresponding to the determined data identifier.

13. One or more non-transitory computer-readable mediums having processor-executable instructions stored thereon for transmitting data from a transmitter of a publisher device to a server and for receiving the data at a receiver of a subscriber device using publish/subscribe middleware that provides to-be-sent data with a data identifier and selects to-be-received data based on the data identifier, wherein the processor-executable instructions, when executed by one or more processors, facilitate:
acquiring, by the publisher device, coordinates of a geographical location of the publisher device within a predetermined coordinate system that is divided into a number of cells via a grid, wherein each cell is provided with a cell identifier and all coordinates of the coordinate system that identify a geographical location are assigned to exactly one cell;
determining, by the publisher device, the cell identifier of the cell to which are assigned the acquired coordinates of the geographical location of the publisher device;
determining, by the publisher device, the data identifier based on the determined cell identifier using a predetermined association rule;
transmitting, by the publisher device via the transmitter, the data together with the data identifier from the publisher device to the server;
storing, by the server, the data on the server;
acquiring, by the subscriber device, the coordinates of a geographical location that is of interest to the subscriber device within the predetermined coordinate system;
determining, by the subscriber device, the cell identifier of the cell to which are assigned the acquired coordinates of the geographical location that is of interest to the subscriber device;
determining, by the subscriber device, the data identifier based on the determined cell identifier using the predetermined association rule; and
receiving, by the subscriber device via the receiver, data from the server corresponding to the determined data identifier.
